(19) United States
(12) Patent Application Publication
(10) Pub. No.: US 2012/0244266 A1
(43) Pub. Date: Sep. 27, 2012

(54) METHOD OF PROCESSING AND MASS-PRODUCING GREEN WHOLE GRAINS

(75) Inventors: Ja-Hyeong KU, Daejeon (KR); Eun-Myeong LEE, Gimje-si (KR); Yun-Kun HUH, Daejeon (KR); Jung-Duck SO, Gongju-si (KR); Jin-Woong CHO, Gyeryong-si (KR); Yong-Soo HWANG, Daejeon (KR); Byeong-Mun LEE, Gunsan-si (KR)

(73) Assignee: The Industry & Academic Cooperation in Chungnam National University (IAC), Daejeon (KR)

(21) Appl. No.: 13/425,885

(22) Filed: Mar. 21, 2012

(30) Foreign Application Priority Data
Mar. 23, 2011 (KR) 10-2011-0025776

(51) Int. Cl. A23B 9/02; A23L 1/182

(52) U.S. Cl. 426/392; 426/461; 426/419

(57) ABSTRACT

A method of processing and mass-producing green whole greens, comprising: a blanching step of discharging the green whole grains stored in the storage tank and steaming the discharged green whole grains for 30 to 120 seconds with water or steam at a temperature ranging from 88 to 102° C.; a cooling step of rapidly cooling the green whole grains which have undergone the blanching step at a temperature ranging from 1 to 7° C.; a cold air dehumidifying step of blowing air to the green whole grains cooled to a low temperature through the cooling step to remove excessive moisture permeated into surfaces of the green whole grains; and a hot air drying step of applying hot air of a low temperature ranging from 35 to 50° C. to the green whole grains from which the excessive moisture has been removed through the cold air dehumidifying step to dry the green whole grains.

### BACKGROUND OF THE INVENTION

1. Field of the Invention

The present invention relates to a method of processing edible green whole grains, and more particularly, to a method of processing and mass-producing green whole grains, by which green whole grains (green-colored whole grains harvested at a mature-green stage before a yellow ripe stage) which conventionally have to be purified (milled or sieved) can be utilized as edible materials or foods, and can be mass-produced.

2. Description of the Related Art

Green whole grains refer to green-colored grains, such as green barley, green wheat, green rice, and green oats, which has not be milled. Grains generally used for staple foods are harvested at a yellow ripe stage, and are threshed, dried, milled, and pulverized. Meanwhile, green whole grains are harvested before ears of barley, wheat, rice, and oats become sufficiently mature in a yellow ripe stage, i.e. in a state where aristae contain green-colored chlorophyll, and are processed to be used as staple foods or edible materials. When grains harvested at a mature stage undergo a milling process, both bran layers and germs are removed so that important nutrients are lost. Further, since unpolished rice contains germs but either aleurone layers or bran layers are not completely removed from unpolished rice, cooked rice is not smoother than in the case of milled rice. Barley should be necessarily boiled to show a certain smooth feeling before it is cooked, and wheat cannot help but be used as a powder product and its germs and bran layers also should be completely removed. Accordingly, in some nations, only whole-wheat flour or germs which are sorted after milled are occasionally used as a product, but the product fails to show an excellent feeling as compared with existing flour and cannot be widely used.

Existing barley is threshed at a yellow ripe stage, and whole barley is inedible. So, after barley is milled (pounded) and then boiled or pressured, it is mixed with rice to be cooked. However, a feeling of barley is not smooth and its rather bitter taste degrades tastes of foods, so barley is mostly used as a health food but its consumption is not increasing. As a result, even when barley is used for a health food, it should be utilized for foods while bran layers and germs having important nutrients of un-cracked grains of barley are lost due to purification and milling.

In order to lessen a rough and hard quality of barley so that barley can be used for foods, although waxy barley having a waxy property has been developed and eaten, we cannot eat whole waxy barley of a high nutritional value without milling barley. Further, although purple barley has been developed and has come into the spotlight as functional grains, its pigment is mainly contained in the bran layers of the whole grains and almost all the pigment layers are lost in the milling process, making difficult to ingest the pigment layers.

Whole grains have abundant nutrition but it is bothersome to cook them. Thus, they are so rough and unsmooth to eat that there is a limit in ingesting them due to indigestion problems. So, only bran layers of grains containing high nutrition are shaved (milled) to make them edible and smooth.

### SUMMARY OF THE INVENTION

The present invention has been made in view of the above problems, and provides a method of processing and mass-producing green whole grains, by which the green whole grains can contain color pigments having functionality and all nutrients while being smooth and chewy so as to be edible.

The present invention also provides a method of processing and mass-producing green whole grains by which green whole grains can be mass-produced economically and efficiently to become an excellent product.

In accordance with an aspect of the present invention, there is provided a method of processing and mass-producing green whole greens, comprising: a storing step of harvesting green-colored whole grains and introducing the harvested whole grains into a storage tank at a mature-green stage before a yellow-ripe stage; a blanching step of discharging the green whole grains stored in the storage tank and steaming the discharged green whole grains for 30 to 120 seconds with water or steam at a temperature ranging from 88 to 102° C.; a cooling step of rapidly cooling the green whole grains which have undergone the blanching step at a temperature ranging from 1 to 7° C.; a cold air dehumidifying step of blowing air to the green whole grains cooled to a low temperature through the cooling step to remove excessive moisture permeated into surfaces of the green whole grains; and a hot air drying step of applying hot air of a low temperature ranging from 35 to 50° C. to the green whole grains from which the excessive moisture has been removed through the cold air dehumidifying step to dry the green whole grains.

Therefore, according to the method of processing and mass-producing green whole grains of the present invention, the green whole grains is so smooth and chewy that they can be convenient to eat. Further, since the green whole grains are tinged with clear green, they can provide freshness visually. Furthermore, their nutrients are very so abundant that green whole grains good for health and prevention of adult diseases can be processed and mass-produced.

Accordingly, the present invention has the following various and excellent effects.

(1) The competitiveness of foods can be secured through the green whole grains of high quality conforming to the requirements of consumers pursuing for well being, making it possible to promote a demand on agricultural products.

(2) The green whole grains can be stably produced through selection of breeds and cultivation technologies suitable for the green whole grains, making it possible to secure profits of the farmers.

(3) Barley producing basis can be secured by mass-producing the import-replacing and exporting green whole grains.

(4) International competitiveness of domestic agricultural product can be secured by constructing a mass-production system for green whole grains.

(5) Adult diseases can be reduced and health of people can be enhanced by a new health food of the green whole grains.

(6) An industrial group can be expanded and new employment can be created by developing products such as machines, apparatuses, and systems specific to various processes for producing the green whole grains.

(7) Product groups of agricultural products can be varied through production of secondary product using the green whole grains.

(8) A seasonal limit can be overcome by making the harvest time of the barley earlier by more than two weeks in the case where the green whole grains can be mass-produced, making it possible to double-crop the barley and rice across the nation.

(9) Expansion of cultivation of the barley and the wheat can create green fields in early spring, improving the scenery of farm villages.

### BRIEF DESCRIPTION OF THE DRAWINGS

The objects, features and advantages of the present invention will be more apparent from the following detailed description in conjunction with the accompanying drawings, in which:

FIG. 1 is a flowchart illustrating a method of processing and mass-producing green whole grains according to the present invention;

FIG. 2 is a block diagram illustrating a system for processing and mass-producing green whole grains according to the present invention;

FIG. 3 is a view schematically illustrating a blanching unit to which a storage tank is connected according to the present invention; and

FIG. 4 is a view schematically illustrating a hot-air drying unit according to the present invention.

### DETAILED DESCRIPTION OF EXEMPLARY EMBODIMENTS

The present invention provides a technology of processing and mass-producing green whole grains, by which green whole grains (green-colored whole grains harvested before the grains are ripened) can be widely utilized as staple foods or edible materials due to their smooth and chewy feelings and appealing colors, making it possible to process and mass-produce green whole grains having more abundant nutrients.

Hereinafter, an exemplary embodiment, advantages, and features of the present invention will be described in detail with reference to the accompanying drawings.

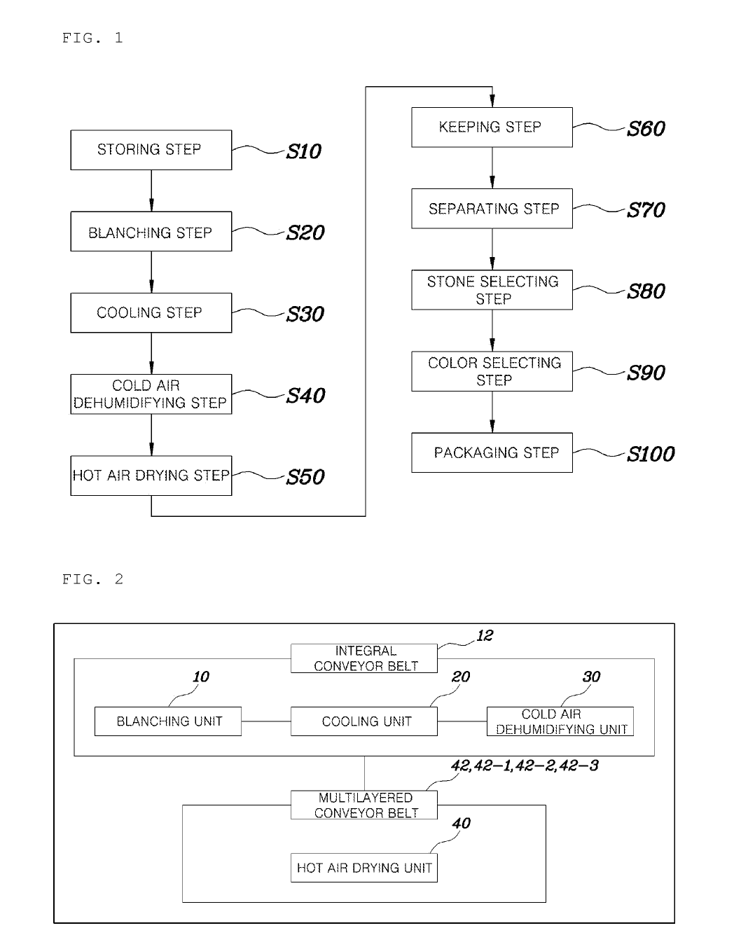

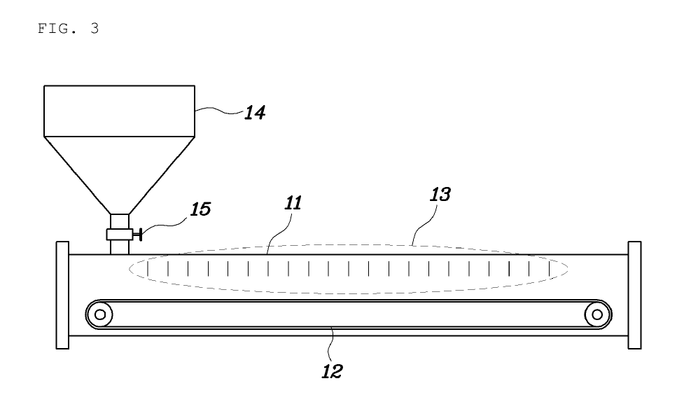

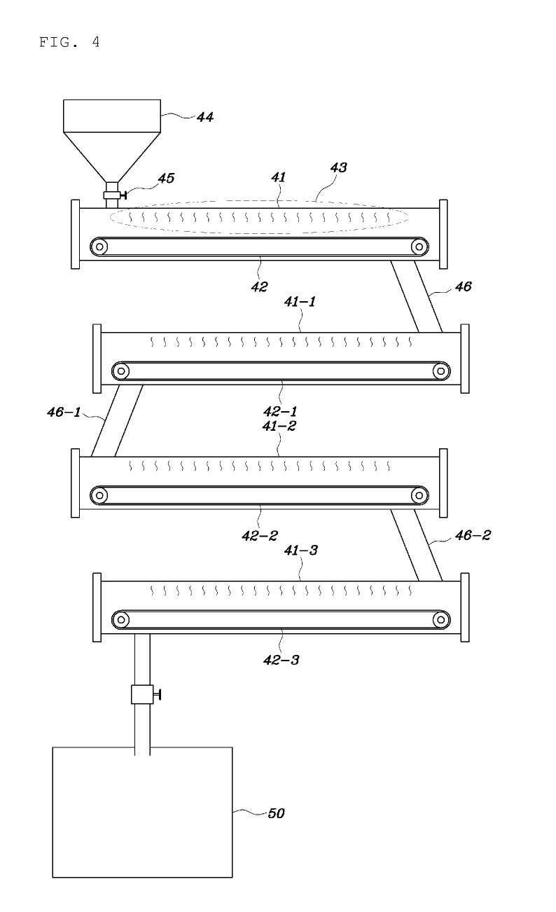

FIG. 1 is a flowchart illustrating a method of processing and mass-producing green whole grains according to the present invention. FIG. 2 is a block diagram illustrating a system for processing and mass-producing green whole grains according to the present invention. FIG. 3 is a view schematically illustrating a blanching unit to which a storage tank is connected according to the present invention. FIG. 4 is a view schematically illustrating a hot-air drying unit according to the present invention.

Referring to FIGS. 1 and 2, the method of processing and mass-producing green whole grains according to the present invention includes a storing step S10, a blanching step S20, a cooling step S30, a cold-air dehumidifying step S40, a hot-air drying step S50, a keeping step S60, a separating step S70, a stone selecting step S80, a color sorting step S90, and a packaging step S100. The above-listed steps are continuously performed through a system including a blanching unit 10, a cooling unit 20, a cold-air dehumidifying unit 30, and a hot-air drying unit 40.

(1) Storing Step (S10)

The storing step S10 of the present invention corresponds to a step of harvesting green whole grains and containing them in the storage tank 14. The green whole grains refer to green-colored whole grains whose ears have been sufficiently mature before a yellow ripe state, i.e. whose seeds have been sufficiently large but still contain chlorophylls, and include grains such as barley, wheat, triticale, rye, oats, and rice.

Thus, the whole grains to be processed according to the present invention should be clipped at a dough ripe stage before a yellow ripe stage to be harvested and threshed. This is because yield rate can be increased when aristae containing many physiologically active materials, such as chlorophyll, vitamin C, and vitamin E, which are not contained in existing yellow grains are harvested and threshed to be processed in an optimum state.

In particular, grains, such as barley, wheat, and oats, which pertain to barley grains causes hard and rough feelings when we eat them, so it is very important to select a waxy breed which has been developed for a high product value. Further, it is advantageous to use large seeds whose aristae ripen uniformly at upper and lower spikes, making it possible to minimize loss of grains due to waste rice in the process of securing uniformity of green whole grains and processing the green whole grains.

When green whole grains are harvested by using grain harvesters (rice combiners), it is necessary for less hardened green grains to be harvested in the form of full grains without being crushed, pressed, or distorted. This can be achieved by adjusting an RPM of a combiner to a relatively low one as compared with the time when yellow grains are clipped in a conventional way.

A harvest time, selection of a breed, and a harvesting method also are important factors for processing and producing green whole grains of a high quality.

First, in selecting a breed, desired breeds for different grains which are suitable for a long harvesting work and a long processing period are selected as follows, considering urgency of a temporary harvesting time in spring.

TABLE 1

| Grains | Breeds |
|---|---|
| Waxy barley | New Waxy barley, Poongsan Waxy |
| | barley, Two-row barley |
| General wheat | Geumgang wheat |
| Waxy rice | Dongjin Waxy rice |
| General rice | Hopum rice |

As in the below-described first embodiment of the present invention, the applicant selected and harvested three kinds of breeds, i.e. New Waxy barley, Poongsan Waxy barley (Ijo barley), and Geumgang wheat which have a waxy property in spring, and selected and harvested two kinds of breeds, i.e. Dongjin Waxy rice and Hopum rice in fall, considering that delivery dates for breeds become faster or later by several days while referring to sowing dates for fields to predict harvesting times of barley, wheat, and rice pertaining to barley grains.

### First Embodiment

The New Waxy Barley was seeded on Oct. 30, 2010 (at a suitable seeding time) in an area of approximately 4000 m² located in Gunsan, Jeollabudo, came into ears on May 2, 2011 (at a suitable earing time), identified a harvest maturity of aristae on May 20, 2011 (at a dough stage), determines an optimum harvesting time to be May 22, 2011 (20 days after the earing time), and was completely harvested by a rice combiner for one and a half hour from 11 O'clock A.M. when the morning dew is dry. The weight per unit weight of the harvested green barley was 3,100 kg, which is heavier than an average weight per unit weight of 2,400 kg of the barley harvested at a yellow ripe stage. This is because the green barley contains more moisture.

Although the barley at a yellow ripe stage can be generally clipped by a rice combiner for 50 minutes in the case of the same area, it is not easy to clip leaves and stems of the barley at a mature green stage. So, the green barley can be prevented from being grinded or pressed by setting a clipping speed of the rice combiner to be lower than a clipping speed of the barley at a yellow ripe stage. Accordingly, the clipping operation of the green whole grains of the present invention takes twice as the conventional clipping operation of the grains at a yellow ripe stage.

Further, grains are prevented from being stacked by employing an awn remover having a mesh less dense that that of a conventional awn remover for clipping grains at a yellow ripe stage.

In the embodiment of seeding and harvesting Poongsan Waxy barley, the Poongsan Waxy Barley was seeded on Oct. 30, 2010 (at a suitable seeding time) in an area of approximately 4000 m² located in Gunsan, Jeollabudo, came into ears on May 10, 2011 (at a suitable earing time of the Poongsan Waxy barley), identified a harvest maturity of aristae on May 28, 2011 (at a mature green stage), determined an optimum harvesting time to be May 30, 2011 (20 days after the earing time), and was completely harvested by a rice combiner for one and a half hour from 11 O'clock A.M. when the morning dew is dry. The weight per unit weight of the harvested green barley was 3,000 kg, which is heavier than an average weight per unit weight of 2,400 kg of the barley harvested at a yellow ripe stage. This is because the green barley contains more moisture.

Although the barley at a yellow ripe stage can be generally clipped by a rice combiner for 40 minutes in the case of the same area, it is not easy to clip leaves and stems of the barley at a mature green stage. So, the green barley can be prevented from being grinded or pressed by setting a clipping speed of the rice combiner to be lower than a clipping speed of the barley at a yellow ripe stage. Accordingly, the clipping operation of the green whole grains of the present invention takes twice as the conventional clipping operation of the grains at a yellow ripe stage.

Further, grains are prevented from being stacked by employing an awn remover having a mesh less dense that that of a conventional awn remover for clipping grains at a yellow ripe stage.

In the embodiment of seeding and harvesting Geumgang wheat, the Geumgang wheat was seeded on Oct. 30, 2010 (at a suitable seeding time) in an area of approximately 4000 m² located in Gunsan, Jeollabudo, came into ears on May 10, 2011 (at a suitable earing time of the wheat), identified a harvest maturity of aristae on May 28, 2011 (at a mature green stage), determined an optimum harvesting time to be May 30, 2011 (20 days after the earing time), and was completely harvested by a rice combiner for one and a half hour from 11 O'clock A.M. when the morning dew is dry. The weight per unit weight of the harvested green wheat was 3,500 kg, which is heavier than an average weight per unit weight of 2,800 kg of the wheat harvested at a yellow ripe stage. This is because the green wheat contains more moisture.

Although the wheat at a yellow ripe stage can be generally clipped by a rice combiner for one hour in the case of the same area, it is not easy to clip leaves and stems of the wheat at a mature green stage. So, the green wheat can be prevented from being grinded or pressed by setting a clipping speed of the rice combiner to be lower than a clipping speed of the wheat at a yellow ripe stage. Accordingly, the clipping operation of the green whole grains of the present invention takes twice as the conventional clipping operation of the grains at a yellow ripe stage.

Further, grains are prevented from being stacked by employing an awn remover having a mesh less dense that that of a conventional awn remover for clipping grains at a yellow ripe stage.

In the embodiment of seeding and harvesting Dongjin Waxy rice and Hopum rice, they are planted on May 30, 2010 (at a suitable planting time) in an area of approximately 4000 m² located in Gunsan, Jeollabudo, came into ears on Aug. 30, 2011 (at a suitable earing time of the rice), identified a harvest maturity of aristae on Sep. 20, 2011 (at a mature green stage), determined an optimum harvesting time to be Sep. 22, 2011 (20 days after the earing time), and was completely harvested by a rice combiner for 40 minutes from 11 O'clock A.M. when the morning dew is dry. The weight per unit weight of the harvested green rice was 5,880 kg, which is heavier than an average weight per unit weight of 4,200 kg of the rice harvested at a yellow ripe stage. This is because the green rice contains more moisture.

A conventional combiner can be utilized as a harvesting device. Although the rice at a yellow ripe stage can be generally clipped by a rice combiner for 30 minutes in the case of the same area, it is not easy to clip leaves and stems of the barley at a mature green stage. So, the green barley can be prevented from being grinded by setting a clipping speed of the rice combiner to be lower than a clipping speed of the barley at a yellow ripe stage.

Husks of the rice have an organization denser than the barley and the wheat, so the awn remover in the rice combiner has a conventional mesh size.

The green whole grains harvested through the above-mentioned method are fed to a processing field and are introduced into the storage tank 14 to undergo a blanching step S20.

The storage tank of the present invention is installed to be communicated with the blanching unit 10, so the green whole grains stored in the storage tank are directly discharged to the blanching unit 10 to undergo the blanching step S20. The storage tank preferably has a conical hopper shape where an amount of the green whole grains can be discharged through a control valve 15 as in FIG. 3.

(2) Blanching Step (S20)

The blanching step of the present invention corresponds to a step of feeding green whole grains through the blanching unit 10 and steaming the green whole grains at a high temperature at the same time.

As illustrated in FIG. 3, the blanching unit 10 of the present invention has a tube-shaped steam tunnel 11 whose interior is hollow and closed and formed long in one direction, and a conveyor belt 12 installed within the steam tunnel 11 to feed the green whole grains discharged from the storage tank 14 in one direction. The blanching unit 10 is configured to eject water of a high temperature or steam 13 to the green whole grains stacked on the conveyor belt 12 to be fed. In particular, in the case of steam, a steam boiler using a lamp oil can be employed as a heat source. Meanwhile, the conveyor belt of the blanching unit 10 preferably employs a stainless wire mesh conveyor belt.

Hereinafter, the blanching step S20 by the blanching unit 10 according to a preferred embodiment of the present invention will be described.

First, after an outlet opening of the hopper type storage tank 14 is opened and green whole grains is discharged to the conveyor belt of the blanching unit 10 before processed, the green whole grains to be processed are stacked on the conveyor belt to be fed in one direction. Then, the green whole grains stacked on the conveyor belt may be preferably stacked while being spread out to have a thickness of 2 to 3 cm. This is because when the blanching step S20 is performed using steam 13, the green whole grains can be efficiently and uniformly steamed in a most advantageous way.

The steaming operation is performed using water of a high temperature or steam. In particular, when steam 13 is used, the steam 13 of a temperature ranging 88 to 102° C. (preferably, 90 to 100° C.) is ejected to the green whole grains. If water is used, the green whole grains are blanched by water of a temperature ranging 88 to 100° C. for 30 to 120 seconds.

The most preferable temperature and process time can be selected and regulated within the above-mentioned range according to a detailed kind and amount of the grains to be processed. The green whole grains completely steamed through the blanching process S20 proceeds to a cooling step S30.

(3) Cooling Step (S30)

Immediately after the blanching step S20 is finished, the green whole grains have a temperature of approximately 80° C. The cooling step S30 of the present invention corresponds to a process of clearly fixing the chlorophylls of the green whole grains by immediately introducing the green whole grains discharged at a high temperature into the cooling unit 20 of the present invention.

The cooling unit 20 of the present invention includes a cooling tunnel whose interior is hollow and closed and formed long in one direction, a conveyor belt installed within the cooling tunnel to receive the green whole grains discharged from the blanching unit and feed the green whole grains in one direction, and a cooler for reducing an interior temperature of the cooling tunnel to a low temperature. Meanwhile, the conveyor belt of the cooling unit 20 preferably employs a stainless wire mesh conveyor belt.

Hereinafter, the cooling step S30 by the cooling unit 20 according to the preferred embodiment of the present invention will be described.

First, the green whole grains having undergone the blanching step S20 form a grain layer having a thickness of 2 to 3 cm on the conveyor belt. The discharged grain layer can clearly fix the chlorophylls of the green whole grains only when it is cooled immediately. Thus, the conveyor belt of the cooling unit 20 includes an integrated conveyor belt 12 continuously connected to the conveyor belt of the blanching unit 10 so that the blanching step S20 and the cooling step S30 can be preferably performed continuously.

The cooling operation is performed while the green whole grains pass through the cooling tunnel whose interior is maintained at a low temperature by a cooler. That is, after the green whole grains of a high temperature (approximately 80° C.) discharged from the blanching unit 10 are introduced into the cooling tunnel and then pass through the cooling tunnel, the green whole grains of the high temperature are rapidly cooled to a low temperature by the low temperature of the cooling tunnel so that the steamed heat of the grains diminish.

Then, a temperature of the cooling tunnel for rapidly cooling the green whole grains of the high temperature is preferably set to 1 to 7° C., and more preferably to a temperature of 2 to 5° C.

The cooling step is preferably performed until a temperature of the green whole grains having a temperature of approximately 80° C. reaches a temperature of 25 to 35° C. (preferably, approximately 30° C.). Thus, the green whole grains having undergone the cooling step are discharged from the cooling tunnel after being cooled to approximately 30° C., and the discharged low-temperature green whole grains proceed to a cold air dehumidifying step S40 subsequently.

As mentioned above, the high-temperature green whole grains having undergone the blanching step S20 are immediately cooled rapidly by performing the blanching step S20 and the cooling step S30 continuously through the integrated conveyor belt 12. Accordingly, the green color of the green whole grains can be maintained, making it possible to produce green whole grains having an excellent color.

(4) Cold Air Dehumidifying Step (S40)

In the cold air dehumidifying step S40 of the present invention, the green whole grains cooled to a low temperature through the cooling step S30 are fed to the cold air dehumidifying unit 30 to remove excessive moisture penetrating into the green whole grains.

The cold air dehumidifying unit 30 of the present invention a cold air dehumidifying tunnel equipped with a plurality of cold air fans for blowing air in a direction where the green whole grains are stacked, and a conveyor belt installed within the cooling tunnel to receive the green whole grains discharged from the blanching unit 10 and feed the green whole grains in one direction.

Meanwhile, the conveyor belt of the cold air dehumidifying unit 30 preferably includes an integral conveyor belt 12 continuously connected to the conveyor belt of the cooling unit to continuously perform the cooling step S30 and the cold air dehumidifying step S40. Further, the conveyor belt of the cold air dehumidifying unit 30 preferably employs a stainless wire mesh conveyor belt.

Hereinafter, the cold air dehumidifying step S40 by the cold air dehumidifying unit 30 according to the preferred embodiment of the present invention will be described.

First, the green whole grains having undergone the cooling step S30 to be discharged contain excessive moisture, in which case the excessive moisture is intensively contained on surfaces (outer surface) of the green whole grains.

In the cold air dehumidifying step S40 of the present invention, the moisture excessively contained on the surfaces of the green whole grains is removed in advance, and the green whole grains are dried more economically and efficiently in a post process (i.e. a hot air drying process) using hot air.

The cold air dehumidifying step S40 of the present invention is performed such that air is blown toward the green whole grains stacked and fed on the conveyor belt by using a plurality of cold air fans installed in the cold air dehumidifying tunnel, in which case an interior temperature of the cold air tunnel, i.e. a blowing temperature is maintained at a temperature of 24 to 25° C.

A plurality of raking bars are installed at an upper portion of the conveyor belt at an inlet of the cold air dehumidifying tunnel such that the green whole grains fed to the cold air dehumidifying tunnel is agitated by the raking bar to perform a cold air dehumidifying operation. It is because the moisture on the surfaces of the green whole grains can be efficiently removed by widening the area of the green whole grains contacting with the blowing wind through the agitating operation.

It is sufficient only if the cold air dehumidifying step S40 is performed such that approximately 7% of the moisture contained in the green whole gains having undergone the cooling process can be reduced. In more detail, the green whole grains to which the cold air dehumidifying step S40 has been completed are processed to have moisture of approximately 50%.

As mentioned above, the moisture excessively contained on the surfaces of the green whole grains can be promptly removed through the cold air dehumidifying step S40 of the present invention, shortening a drying time during the below-described hot air drying step S50 and reducing power consumption for generation of hot air.

The applicant performs the blanching step S20, the cooling step S30, and the cold air dehumidifying step which have been described above according to the second embodiment of the present invention, which will be confirmed in Table 2.

### Second Embodiment

In the second embodiment of the present invention, the blanching step S20, the cooling step S30, and the cold air dehumidifying step S40 were performed in the following condition. For reference, the stainless wire mesh conveyor belt employed as a green whole grain feeding means in the blanching step S20, the cooling step S30, and the cold air dehumidifying step S40 was an integral conveyor belt 12 connected continuously so that the steps were continuously performed.

(1) Objects (Breed) to Be Processed: The objects to be processed were green whole grains such as Golden Twilight, Hopum, SamGwang, Donjin Waxy, Jewel Waxy, Baekok Waxy containing 55% of moisture.

(2) Blanching Step: The stainless wire mesh conveyor belt was employed as a green whole grain feeding means, and the green whole grains were stacked on the conveyor belt to have 2.5 cm and passed through the steam tunnel 11 of 3.5 m. Each of a group of the same breeds were steamed for 30 seconds by using steam of 100±1.5° C. and another group of the same breeds were steamed for 60 seconds.

The temperature of the green whole grains to which the above-conditioned blanching step was performed and which was discharged was 80° C. and has moisture of 57%.

(3) Cooling Step: A stainless wire mesh conveyor belt was employed as a green whole grain feeding means. The green whole grains having a temperature of 80° C. discharged from the steam tunnel 11 to a grain layer of 2.5 cm were immediately introduced into the cooling tunnel having a length of 1.5 cm and passed through the steam tunnel 11 for 40 seconds, so that the green whole grains of a high temperature were rapidly cooled.

The green whole grains to which the cooling step S30 was performed and which was discharged were cooled to 30° C.

(4) Cold Air Dehumidifying Step: A stainless wire mesh conveyor belt is employed as a green whole grain feeding means, and the green whole grains cooled to a temperature of 30° C. through the cooling step S30 passed through a tunnel having a length of 10 m and having twenty cold air fans blowing air to a lower side while being fed to the conveyor belt. Six raking bars are installed at an upper portion of an interior inlet of the cold air dehumidifying tunnel, and the green whole grains passed through the cold air dehumidifying tunnel for twenty minutes while being stirred.

A temperature of the green whole grains to which the above conditioned cold air dehumidifying step was performed and which were discharged was 25° C., and the amount of moisture was lowered from an average of 57% to 50%. Thus, the amount of moisture in the green whole grains could be lowered by approximately 7% through the cold air step.

The green whole grains (i.e. the green whole grains before the hot air drying step) to which the blanching step, the cooling step, and the cold air dehumidifying step were performed have the colors of Table 2.

TABLE 2

| | Blanching | Hunter value | | |
|---|---|---|---|---|
| Breed | Time | L | a | b |
| Golden | 30 | 50.15 | −10.91 | 33.77 |
| Twilight | seconds | | | |
| | 60 | 44.47 | −11.30 | 34.03 |
| | seconds | | | |
| Hopum | 30 | 47.63 | −10.40 | 33.80 |
| | seconds | | | |
| | 60 | 45.26 | −9.91 | 31.60 |
| | seconds | | | |
| SamGwang | 30 | 52.84 | −9.58 | 31.86 |
| | seconds | | | |
| | 60 | 49.94 | −8.90 | 30.32 |
| | seconds | | | |
| Dongjin | 30 | 52.37 | −8.39 | 32.76 |
| Waxy | seconds | | | |
| | 60 | 53.26 | −7.45 | 32.86 |
| | seconds | | | |
| Jewel | 30 | 54.14 | −8.83 | 33.05 |
| Waxy | seconds | | | |
| | 60 | 52.86 | −9.34 | 32.98 |
| | seconds | | | |
| Baekok | 30 | 52.92 | −9.73 | 35.79 |
| Waxy | seconds | | | |
| | 60 | 51.53 | −10.71 | 33.84 |
| | seconds | | | |

Here, L denotes brightness. A (+) value of a denotes redness and a (−) value of a denotes greenness. The larger a (−) value is, the denser the greenness is. The larger b is, the denser the yellowness is. The smaller b is, the denser the greenness is.

Referring to Table 2, when the green whole grains are processed through the blanching step S20, the cooling step S30, and the cold air dehumidifying step S40, they can maintain the conventional dense green color.

However, it can be seen that the greenness of the green whole grains can be improved or degraded as the blanching time for each breed becomes longer or shorter. Thus, the green whole grains showing an excellent green color can be processed and produced by selecting or regulating the blanching time within a suitable time range (i.e. 30 to 120 seconds) suggested by the present invention.

The green whole grains processed while undergoing the blanching step S20, the cooling step S30, and the cold air dehumidifying step of the present invention are soft and chewy, so they contain endosperms, germs, and bran layers containing all nutrients before the processing.

However, the processed green whole grains should prevent changes and losses of nutrients, and it is necessary to further lower moisture by drying the grains to preserve unique smells and tastes. Thus, the hot air drying step S50 of the present invention was suggested.

(5) Hot Air Drying Step (S50)

In the hot air drying step S50 of the present invention, the green whole grains from which excessive moisture has been removed through the cold air dehumidifying step S40 are introduced into the hot air drying unit 40 to be dried by applying a low-temperature hot air while being fed.

The hot air drying unit 40 of the present invention includes a hot air drying tunnel 41 an interior of which is hollow and closed and formed long in one direction, a conveyor belt 42 installed within the hot air drying tunnel 41 to feed the green whole grains in one direction, and a hot air blower for generating hot air 43.

Meanwhile, the conveyor belt 42 of the hot air drying tunnel 41 preferably employs a filter cloth fiber mesh conveyor belt of a PE material, and the green whole grains stacked and fed on the conveyor belt 42 are stirred in an agitating operation, making it possible to promptly and efficiently dry the green whole grains.

In particular, a plurality of hot air drying tunnels 41, 41-1, 41-2, 41-3, . . . equipped with conveyor belts 42, 42-1, 42-2, 42-3, . . . respectively are installed to have a multilayered structure so that the hot air drying unit 40 of the present invention can collectively dry a larger amount of grains to which the cold air dehumidifying operation was performed and which was introduced. The hot air drying tunnels 41, 41-1, 41-2, 41-3, . . . are communicated with each other through hollow continuous lines 46, 46-1, 46-2, . . . , so the large amount of grains are transferred to the lower conveyor belt through the continuous line by stages, making it possible to dry a large amount of grains.

Hereinafter, the hot air drying step S50 by the hot air drying unit 40 according to the preferred embodiment of the present invention will be described.

First, the green whole grains containing moisture of approximately 50% to which the cooling step was performed are introduced into the uppermost conveyor belt 42 of the multilayered conveyor belts 42, 42-1, 42-2, 42-3, . . . by using an introduction unit 44 to be uniformly spread out and stacked. Meanwhile, the introduction unit may employ a hopper by which an amount of discharged grains can be regulated through a regulation value 45.

A primary drying operation is performed by wind at the room temperature for about one and a half hour including the introduction time, in which case the primary drying operation can be smoothly performed by reducing a rotating speed of the conveyor belt.

After one and a half hour elapses until the completion of the introduction and the drying operation at the room temperature, a rotating speed of the conveyor belt 42 is reduced for six hours and a low-temperature hot air 43 of 35 to 50° C. (preferably, around 45° C.) is applied to perform the drying operation, in which case the drying operation is preferably performed until the moisture of the green whole grains reaches 11 to 17%. In more detail, an optimum limit content of the moisture per grain for preventing a change of quality during storage/keeping/circulation of the processed and produced green whole grains.

That is, the green barley and the green wheat are dried to 12 to 14% and are stored and kept in a storage tank 50 (a keeping step: S60). The green rice is dried to 15 to 16% and is stored and kept (a keeping step: S60) in the storage tank 50.

The green whole grains having undergone the hot air drying step S50 is preferably contained, stored, and kept to maintain a moisture content of 11 to 17%, in which case the storing/keeping temperature may be 5 to 10° C. More preferably, the storing/keeping temperature is most preferably maintained at a temperature of 5 to 6° C. in spring and summer and is maintained at a temperature of 10° C. in fall and winter.

After keeping and storing the processed green whole grains at the temperature and humidity according to the present invention, the applicant confirmed that the nutrients and greenness of the green rice, the green barley, and the green wheat are maintained as they are after 6 months, and only the color of the color wheat was changed by approximately 5% after one year.

When the drying operation is performed by using the low-temperature hot air, the drying time of the hot air drying step S50 can be remarkably reduced by using a discharge nozzle for discharging dried air and a suction nozzle for compulsorily suctioning air.

That is, the discharge nozzle for discharging the dried air is installed at an upper portion of the filter cloth fiber mesh conveyor belt 42 to eject the dried air toward the green whole grains stacked on the filter cloth fiber mesh conveyor belt 42.

The suction nozzle for compulsorily suctioning air is installed at a lower portion of the filter cloth fiber mesh conveyor belt 42 to suction the green whole grains and the air humidified while passing through the filter cloth fiber mesh conveyor belt 42 and discharge the wet air to the outside through an exhaust duct, making it possible to dry a large amount of green whole grains promptly for a short time without delaying or putting off the drying step.

If a dehumidifier is further installed at an introduction opening through which air is introduced into the hot air drying tunnel 41 to introduce dried air and perform a hot air drying operation, the drying time can be further shortened and freshness can be maintained.

The reason why it is important to shorten the drying time is that it is advantageous in mass production, and as the driving time becomes longer, the grains may be damaged, modified, or discolored.

As mentioned above, if the hot air drying step S50 based on the multilayered continuous line type conveyor belt 42, 42-1, 42-2, and 42-3 is completed via the blanching step S20, the cooling step S30, and the cold air dehumidifying step S40 based on the integral conveyor belt 12, the tastes are soft and chewy, the colors are clearly green, and the nutrients are very abundant.

Since the obtained green whole grains still contain hulls and foreign substance, the present invention further includes a separating step S70, a stone selecting step S80, a color selecting step S90, and a packaging step S100.

(6) Separating Step (S70) and Stone Selecting Step (S80)

The separating step S70 of the present invention is a step of removing the hulls of the green whole grains dried through the low-temperature hot air. In the separating step S70, the green whole grains preferably pass through a pair of rollers spaced apart by a predetermined interval and disposed opposite to each other, so that only the hulls of the green whole grains can be removed.

While the green rice can be obtained by using a conventional rice huller, the green barley and the green wheat can be obtained not by using a barley pearling machine but by using a dedicated awn remover. That is, a metallic grinder roller in a conventional rice huller method used to remove only bran of rice is replaced by a rubber roller, and an interval between the rollers are regulated to an interval suitable for a circular size of the grains. The grains pass through the rollers, making it possible to remove the hulls of the grains while protecting germs and bran layers.

Meanwhile, when the separating step S70 is performed by the dedicated awn remover, about one third of the amount of introduced grains are introduced and a rotating speed of the rollers are set to be low, making it possible to obtain whole grains with no scratch.

If the separating step S70 is completed, stones and foreign substances are removed from a conventional separator.

(7) Color Selecting Step (S90) and Packaging Step (S100)

If the stone selecting for removing foreign substances including stones is completed, only the green whole grains maintaining allowable greenness are selected by using a general color selector.

The selection of colors is completed, the green whole grains are packaged by utilizing a conventional automatic packing machine and production and commercialization of the green whole grains are finally completed. Meanwhile, it is preferable that a harmless oxidation preventing agent is packaged together with the contents (grains) to maintain freshness.

As discussed above, the green whole grains processed and produced according to the method of processing the green whole grains of the present invention contain nutrients undamaged, and when they are used for cooking, the tastes are soft and chewy. Further, the dietary fibers of the bran layers exist in a water soluble state, which is suitable for digestion. The natural chlorophyll and pigments contained in the green whole grains are left in the bran layers of the grains, showing colorfulness.

Further, the green whole grains can be promptly and efficiently produced through the blanching step S20, the cooling step S30, and the cold air dehumidifying step S40 continuously performed based on the integral conveyor belt 12, and the continuous line type conveyor belt having a multilayered structure, making it possible to minimize power consumption and mass-produce the green whole grains.

Although an exemplary embodiment of the present invention has been described for illustrative purposes, those skilled in the art will appreciate that the present invention is not limited to the exemplary embodiment of the present invention and various changes and modifications are possible, without departing from the scope and spirit of the invention as disclosed in the accompanying claims. Therefore, those skilled in the art will appreciate that the changes and modifications are not separated from the technical aspect or spirit of the present invention and modified embodiments belongs to the appended claims of the present invention.

What is claimed is:

1. A method of processing and mass-producing green whole greens, comprising:
a storing step of harvesting green-colored whole grains and introducing the harvested whole grains into a storage tank at a mature-green stage before a yellow-ripe stage;
a blanching step of discharging the green whole grains stored in the storage tank and steaming the discharged green whole grains for 30 to 120 seconds with water or steam at a temperature ranging from 88 to 102° C.;
a cooling step of rapidly cooling the green whole grains which have undergone the blanching step at a temperature ranging from 1 to 7° C.;
a cold air dehumidifying step of blowing air to the green whole grains cooled to a low temperature through the cooling step to remove excessive moisture permeated into surfaces of the green whole grains; and
a hot air drying step of applying hot air of a low temperature ranging from 35 to 50° C. to the green whole grains from which the excessive moisture has been removed through the cold air dehumidifying step to dry the green whole grains.

2. The method of claim 1, further comprising a keeping step of maintaining a moisture containing rate of the green whole grains which have been dried by the hot air of the low temperature at 11 to 17%, and storing the green whole grains at a temperature of 5 to 10° C. with the green whole grains not being separated.

3. The method of claim 1, further comprising:
a separating process of removing hulls of the green whole grains which have been dried by the hot air of the low temperature;
a stone selecting step of removing foreign substances contained in the separated green whole grains;
a color sorting step of sorting only the green whole grains maintaining the greenness among the green whole grains which have undergone the stone selecting step; and
a packaging step of packaging the green whole grains which have been finally acquired through the color sorting step.

4. The method of claim 1, wherein in the blanching step, the green whole grains are stacked on a conveyor belt to have a thickness of 2 to 3 cm, and are fed and steamed.

5. The method of claim 1, wherein in the cooling step, the green whole grains are cooled while being stacked and fed on a conveyor belt so that a temperature of the green whole grains reaches 25 to 35° C.

6. The method of claim 1, wherein in the cold air dehumidifying step, excessive moisture is removed from the green whole grains while the green whole grains are stacked and fed on a conveyor belt, and wherein the method further comprises an agitating step of agitating the green whole grains with a raking bar installed at an upper portion of the conveyor belt.

7. The method of claim 1, wherein the blanching step, the cooling step, and the cold air dehumidifying step are continuously performed while the green whole grains are stacked and fed on an integrally connected conveyor belt.

8. The method of claim 4, wherein the conveyor belt is a stainless wire mesh conveyor belt.

9. The method of claim 1, wherein in the hot air drying step, the green whole grains are stacked and fed on a conveyor belt having a multi-layered structure and connected in a continuous line to be dried.

10. The method of claim 9, wherein the conveyor belt is a filter cloth fiber mesh conveyor belt.

11. The method of claim 10, wherein dry air is injected toward the green whole grains stacked on the filter cloth fiber mesh conveyor belt with a discharge nozzle installed at an upper portion of the filter cloth fiber mesh conveyor belt to discharge dry air, and air which has been humidified while passing through the green whole grains and the filter cloth fiber mesh conveyor belt is suctioned to be discharged to the outside with a suction nozzle installed at a lower portion of the filter cloth fiber mesh conveyor belt to compulsorily suction air.

12. The method of claim 3, wherein in the separating step, only the hulls of the green whole grains are removed while passing between a pair of rollers at least outer surfaces of which are formed of a rubber material and which are disposed opposite to each other.

13. The method of claim 1, wherein the green whole grains are selected from New Waxy barley, Poongsan Waxy barley (Ijo barley), and Geumgang wheat which have a waxy property in spring, and are selected from Dongjin Waxy rice and Hopum rice in fall.

14. The method of claim 5, wherein the conveyor belt is a stainless wire mesh conveyor belt.

15. The method of claim 6, wherein the conveyor belt is a stainless wire mesh conveyor belt.

16. The method of claim 7, wherein the conveyor belt is a stainless wire mesh conveyor belt.
